(19) United States
(12) Patent Application Publication
(10) Pub. No.: US 2026/0242229 A1
(43) Pub. Date: Aug. 20, 2026

(54) METHOD FOR MANUFACTURING LITHIUM HYDROXIDE

(71) Applicant: IDEMITSU KOSAN CO.,LTD., Tokyo (JP)

(72) Inventors: Daisuke MORI, Chiyoda-ku, Tokyo (JP); Toshiaki TSUNO, Chiyoda-ku, Tokyo (JP); Futoshi UTSUNO, Chiyoda-ku, Tokyo (JP)

(73) Assignee: IDEMITSU KOSAN CO.,LTD., Tokyo (JP)

(21) Appl. No.: 19/160,943

(22) PCT Filed: Mar. 22, 2024
(86) PCT No.: PCT/JP2024/011385

§ 371 Date: Aug. 29, 2025

(30) Foreign Application Priority Data
Mar. 29, 2023 (JP) 2023-053327

(51) Int. Cl. C01D 15/02; B01D 61/42; C01D 1/30; C01D 1/32; C01D 1/40; C01F 11/18; H01M 10/54

(52) U.S. Cl. CPC C01D 15/02; B01D 61/422; C01D 1/30; C01D 1/32; C01D 1/40; C01F 11/18; H01M 10/54; C01P 2006/40; C01P 2006/80

(57) ABSTRACT

A method for producing lithium hydroxide including mixing a solid raw material containing lithium carbonate, and a calcium compound, in a medium, so as to provide a calcium carbonate-containing liquid, subjecting the calcium carbonate-containing liquid to solid-liquid separation, so as to remove a solid matter containing calcium carbonate, recovering lithium ion from a lithium ion aqueous solution obtained through the solid-liquid separation, to a recovery liquid, with an electrochemical apparatus including a lithium permselective membrane, and obtaining lithium hydroxide from the recovery liquid, the lithium ion aqueous solution having a concentration of lithium ion of 3,000 ppm by mass or more.

### FIELD OF INVENTION

The present invention relates to a method for producing lithium hydroxide.

### TECHNICAL FIELD

As batteries used in information-related devices and communication devices, such as personal computers, video cameras, and mobile phones, lithium secondary batteries and the like have been used in recent years, and the use thereof for hybrid vehicles and electric vehicles, which are developed to address the carbon dioxide gas emission regulation, has also been studied in recent years. Accordingly, there has been an urgent demand to secure the lithium source more than ever, and as a part thereof, a technique for recovering lithium by recycling lithium secondary batteries has been developed (see, for example, PTL 1).

The known lithium recovery techniques also include a recovery method including a process in which battery powder obtained by treating scraps of lithium ion batteries is made into contact with an infusion liquid containing water, to which calcium hydroxide is added to allow lithium hydroxide to effuse (see, for example, PTL 2) and a refining method of lithium hydroxide in which an alkali hydroxide is added to a solution having lithium carbonate dissolved therein, and lithium hydroxide obtained through solid-liquid separation is dried under the prescribed condition (see, for example, PTL 3). A method in which lithium carbonate is reacted with an acid including acetic acid to form lithium acetate, and then lithium acetate and a metal hydroxide are reacted to form lithium hydroxide is also known (see, for example, PTL 4).

### CITATION LIST

### Patent Literatures

PTL 1: JP 2019-81953 A
PTL 2: JP 2019-178395 A
PTL 3: JP 2012-106874 A
PTL 4: JP 2019-131448 A

### SUMMARY OF INVENTION

The present invention has been made under the circumstances, and an object thereof is to provide a method for producing lithium hydroxide that is capable of efficiently producing lithium hydroxide having a high purity from low-grade lithium carbonate containing impurities, such as brine water.

### Solution to Problem

The method for producing lithium hydroxide according to the present invention is a method for producing lithium hydroxide including mixing a solid raw material containing lithium carbonate, and a calcium compound, in a medium, so as to provide a calcium carbonate-containing liquid, subjecting the calcium carbonate-containing liquid to solid-liquid separation, so as to remove a solid matter containing calcium carbonate, recovering lithium ion from a lithium ion aqueous solution obtained through the solid-liquid separation, to a recovery liquid, with an electrochemical apparatus including a lithium permselective membrane, and obtaining lithium hydroxide from the recovery liquid, the lithium ion aqueous solution having a concentration of lithium ion of 3,000 ppm by mass or more.

### Advantageous Effects of Invention

The present invention can provide a method for producing lithium hydroxide that is capable of efficiently producing lithium hydroxide having a high purity from low-grade lithium carbonate containing impurities, such as brine water.

### BRIEF DESCRIPTION OF DRAWINGS

FIG. 1 is a flow chart showing one preferred embodiment of the method for producing lithium hydroxide of the present embodiment.

FIG. 2 is a schematic illustration showing one preferred embodiment of the electrochemical apparatus including a lithium permselective membrane that can be used in the method for producing lithium hydroxide of the present embodiment.

### DESCRIPTION OF EMBODIMENTS

The method for producing lithium hydroxide of one embodiment of the present invention (which may be hereinafter referred to as a “present embodiment”) will be described. In the description herein, the upper limit and lower limit values of the numerical ranges shown with “or more”, “or less”, and “to” are values that can be optionally combined, and the values in the examples can be used as the upper limit and lower limit values. The provisions that are considered to be preferred each may be optionally adopted. Specifically, one provision that is considered to be preferred can be adopted by combining with one or multiple other provisions that are considered to be preferred. A combination of preferred provisions can be considered to be more preferable.

The method for producing lithium hydroxide according to one embodiment of the present invention is merely one embodiment of the method for producing lithium hydroxide of the present invention, and the present invention is not limited to the method for producing lithium hydroxide according to one embodiment of the present invention. In the description herein, lithium means both lithium and lithium ion, and should be appropriately interpreted unless technical contradiction occurs.

### (Knowledge Obtained by Present Inventors Reaching Present Invention)

The present inventors have made earnest investigations for solving the problems, and as a result, have found the following matters, and the present invention has been completed.

The technique described in PTL 1 is to recover lithium ion from the source liquid containing lithium ion using a lithium ion conductor, and the lithium permselective membrane is a considerably useful technique. However, according to the increasing demand of lithium in recent years, the enhancement of the lithium recovery efficiency is being demanded more than ever, and it has been found that there is a room of improvement in the overall efficiency of the production method for providing lithium hydroxide.

The technique described in PTL 4 uses acetic acid, and it has been found that acetic acid is of high cost and is volatile, which increases the equipment cost, and there is a problem in reducing the cost.

The technique described in PTL 2 includes the process in which battery powder is made into contact with an infusion liquid containing water, so as to generate lithium hydroxide through the infusion process of reacting lithium carbonate in the infusion liquid and calcium hydroxide, and then lithium carbonate is to provide through a solid-liquid separation process and a Li carbonation process. However, what is assumed after the infusion process is only providing lithium carbonate through a solid-liquid separation process and a Li carbonation process, and there is no focus on obtaining lithium hydroxide contained in the infusion liquid. Therefore, PTL 2 neither identifies nor suggests the problem of providing lithium hydroxide having a high purity. Furthermore, PTL 2 includes only the solid-liquid separation process after the infusion process, and it is considered that the infusion liquid formed in the infusion process contains residues including calcium ion. Therefore, there is a problem of deteriorating the purity of lithium carbonate to be obtained, but there is no mention of the problem.

The technique described in PTL 3 includes the refining process in which an alkali hydroxide is added to a lithium carbonate solution, and then lithium hydroxide obtained through solid-liquid separation is dried under the prescribed condition. The problem to be solved by the invention described in PTL 3 is to prevent deviation in composition of crystalline water of the resulting lithium hydroxide, and the drying under the prescribed condition is adopted for solving the problem. However, PTL 3 only describes the drying of the filtrate containing lithium hydroxide obtained through the solid-liquid separation, and therefore, it is considered that the filtrate contains residues including calcium ion. Therefore, there is a problem of deteriorating the purity of lithium hydroxide to be obtained, but there is no mention of the problem.

As described above, the ordinary lithium recovery techniques including reacting lithium carbonate and calcium hydroxide to provide lithium hydroxide involve a problem of deterioration in the purity of the lithium compound to be obtained due to the formation of impurities derived from the remaining calcium ion. The present inventors have found that the ordinary techniques involve deterioration of the purity of the lithium compound due to the presence of the remaining calcium ion, and based thereon, have made investigations focusing on whether the remaining calcium ion can be decreased and whether the purity can be prevented from being deteriorated even though the calcium ion remains.

In the investigations performed, the present inventors have found that the use of a lithium permselective membrane achieves lithium hydroxide having a high purity.

### (Embodiments of Present Embodiment)

The methods for producing lithium hydroxide according to first to sixteenth embodiments of the present embodiment, the electrochemical apparatus according to the seventeenth embodiment thereof, the method for producing a lithium-containing substance according to the eighteenth embodiment thereof, and the method for producing a lithium ion battery according to the nineteenth embodiment thereof will be described below.

The method for producing lithium hydroxide according to the first embodiment of the present embodiment is
a method for producing lithium hydroxide including
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate,
recovering lithium ion from a lithium ion aqueous solution obtained through the solid-liquid separation, to a recovery liquid, with an electrochemical apparatus including a lithium permselective membrane, and
obtaining lithium hydroxide from the recovery liquid.
the lithium ion aqueous solution having a concentration of lithium ion of 3,000 ppm by mass or more.

For recovering lithium from a solid raw material containing lithium carbonate to provide lithium hydroxide, it is effective to recover lithium by reacting lithium carbonate and a calcium compound to form calcium carbonate. However, the use of a calcium compound causes calcium ion to remain, and thereby a problem of deterioration of the purity of the lithium compound, such as lithium hydroxide, occurs. The present inventors have made further investigations, and have found that the use of an electrochemical apparatus including a lithium permselective membrane enables the recovery of only lithium ion. The further investigations thereby have revealed that even under an unfavorable condition with a calcium compound used and calcium ion remaining, lithium hydroxide having a high purity can be obtained by using an electrochemical apparatus including lithium permselective membrane and retaining the concentration of lithium ion to the prescribed value or more, i.e., 3,000 ppm by mass.

Consequently, the method for producing lithium hydroxide of the present embodiment can efficiently produce lithium hydroxide having a high purity from low-grade lithium carbonate containing impurities, such as brine water.

In the production method of the present embodiment, firstly, a solid raw material containing lithium carbonate, and a calcium compound are mixed in a medium, so as to react lithium carbonate and the calcium compound, resulting in calcium carbonate. The reaction enables recovery of lithium from lithium carbonate, and calcium carbonate formed can be easily separated through solid-liquid separation, resulting in a lithium ion aqueous solution containing a large amount of lithium ion. Subsequently, the lithium ion aqueous solution containing lithium ion in the prescribed concentration or more is fed to the electrochemical apparatus including a lithium permselective membrane, thereby efficiently recovering only lithium, and thus lithium hydroxide having a high purity can be efficiently produced.

The method for producing lithium hydroxide according to the second embodiment of the present embodiment is the first embodiment, in which
the calcium compound is at least one kind selected from calcium hydroxide and calcium chloride, and
the method for producing lithium hydroxide according to the third embodiment thereof is the second embodiment, in which
the calcium compound is calcium hydroxide.

In the case where only calcium hydroxide, only calcium chloride, or a combination of calcium hydroxide and calcium chloride is used as the calcium compound, only lithium can be recovered more efficiently, enabling the more efficient production of lithium hydroxide having a high purity. Among these, the use of calcium hydroxide enables the further efficient recovery of lithium and the further efficient production of lithium hydroxide having a high purity.

The method for producing lithium hydroxide according to the fourth embodiment of the present embodiment is any one of the first to third embodiments, in which
the lithium ion aqueous solution has a concentration of calcium ion contained therein of 20 ppm by mass or less.

The production method of the present embodiment enables the efficient recovery of only lithium and the efficient production of lithium hydroxide having a high purity even though calcium ion remains. With a smaller concentration of calcium ion in the lithium ion aqueous solution, only lithium can be recovered more efficiently, enabling the more efficient production of lithium hydroxide having a high purity.

The method for producing lithium hydroxide according to the fifth embodiment of the present embodiment is any one of the first to fourth embodiments, in which
the method further includes subjecting the lithium ion aqueous solution to a chelate treatment, and
the method for producing lithium hydroxide according to the sixth embodiment thereof is the fifth embodiment, in which
the lithium ion aqueous solution after the chelate treatment has a concentration of calcium ion of 10 ppm by mass or less.

The chelate treatment performed facilitates the reduction of the concentration of calcium ion in the lithium ion aqueous solution, and can achieve a significantly low concentration thereof, which is preferably 10 ppm by mass or less. Accordingly, only lithium can be recovered more efficiently, enabling the more efficient production of lithium hydroxide having a high purity.

The method for producing lithium hydroxide according to the seventh embodiment of the present embodiment is any one of the first to sixth embodiments, in which
the method includes washing the solid matter with a washing fluid, and subjecting a washed matter formed through the washing to solid-liquid separation, and
the method for producing lithium hydroxide according to the eighth embodiment thereof is the seventh embodiment, in which
a liquid obtained through the solid-liquid separation of the washed matter is mixed with the lithium ion aqueous solution.

The solid matter containing calcium carbonate can be removed by subjecting the calcium carbonate-containing liquid to solid-liquid separation. The solid matter containing calcium carbonate thus removed entrains and contains an aqueous solution containing lithium hydroxide. By washing the solid matter with the washing fluid, calcium carbonate can be washed, and lithium hydroxide entrained in the solid matter can be allowed to be contained in the washing fluid.

Accordingly, the washed matter formed through the washing contains the washed calcium carbonate as a solid matter, and also contains a liquid containing lithium hydroxide. Therefore, the solid-liquid separation of the washed matter can separate the washed calcium carbonate and the liquid containing lithium hydroxide. The crystallization is performed for the liquid containing lithium hydroxide, and therefore, a larger amount of lithium can be recovered by mixing the liquid with the lithium ion aqueous solution.

### Liquid Obtained Through Solid-Liquid Separation of the Washed Matter

The method for producing lithium hydroxide according to the ninth embodiment of the present embodiment is any one of the first to eighth embodiments, in which
an amount of the calcium compound used is 1.0 mol or more and 2.0 mol or less per 1.0 mol of lithium carbonate.

In the case where the amount of the calcium compound used per lithium carbonate contained in the solid raw material is in the range, the concentration of lithium ion contained in the lithium ion aqueous solution can be more easily allowed to be 3,000 ppm by mass or more. Therefore, only lithium can be recovered more efficiently, enabling the more efficient production of lithium hydroxide having a high purity.

The method for producing lithium hydroxide according to the tenth embodiment of the present embodiment is any one of the first to ninth embodiments, in which
the recovering to the recovery liquid is performed at a temperature regulated to 50° C. or more.

For the efficient recovery of lithium ion with the electrochemical apparatus including a lithium permselective membrane, the concentration of lithium ion in the lithium ion aqueous solution is necessarily the prescribed concentration or more, and the concentration of calcium is preferably lower. In addition to these, the recovery to the recovery liquid performed under a temperature condition regulated to 50° C. or more is also effective for the efficient recovery of lithium ion. Specifically, by performing the recovery to the recovery liquid at a temperature regulated to 50° C. or more, only lithium can be recovered more efficiently, enabling the more efficient production of lithium hydroxide having a high purity.

The method for producing lithium hydroxide according to the eleventh embodiment of the present embodiment is any one of the first to tenth embodiments, in which
the recovering to the recovery liquid is performed at a pH of the lithium ion aqueous solution regulated to 11 or more and 14 or less.

By regulating the pH of the lithium ion aqueous solution to 11 or more and 14 or less in addition to the aforementioned temperature condition, only lithium can be recovered more efficiently, enabling the more efficient production of lithium hydroxide having a high purity.

The method for producing lithium hydroxide according to the twelfth embodiment of the present embodiment is any one of the first to eleventh embodiments, in which
the obtaining lithium hydroxide from the recovery liquid is performed by performing solid-liquid separation through crystallization of the recovery liquid.

In obtaining lithium hydroxide from the recovery liquid obtained by recovering lithium ion in the electrochemical apparatus including lithium permselective membrane, the solid-liquid separation performed through crystallization of the recovery liquid enables the easier production of lithium hydroxide having a high purity.

The method for producing lithium hydroxide according to the thirteenth embodiment of the present embodiment is any one of the first to twelfth embodiments, in which
the solid raw material contains at least one kind of an atom selected from a sodium atom, a potassium atom, a magnesium atom, a calcium atom, an iron atom, a cobalt atom, a nickel atom, a zinc atom, an aluminum atom, a silicon atom, a lead atom, a boron atom, a phosphorus atom, a sulfur atom, a fluorine atom, a chlorine atom, and a bromine atom.

The solid raw material used in the production method of the present embodiment contains lithium carbonate, i.e., contains a lithium element, a carbon element, and an oxygen element, and in addition to these elements, may contain at least one kind of an element selected from an iron element and the other aforementioned element. Accordingly, the production method of the present embodiment can use a solid raw material containing the assorted elements, for example, low-grade lithium carbonate containing impurities, such as brine water, as the solid raw material, with which lithium hydroxide having a high punty can be efficiently produced.

The method for producing lithium hydroxide according to the fourteenth embodiment of the present embodiment is any one of the first to thirteenth embodiments, in which
lithium hydroxide obtained in the obtaining lithium hydroxide is at least one kind selected from lithium hydroxide monohydrate and anhydrous lithium hydroxide.

The production method of the present embodiment can produce a monohydrate or an anhydrate as the resulting lithium hydroxide. For example, a monohydrate can be obtained in the case where lithium hydroxide is recovered from the recovery liquid through crystallization. In the case where an anhydrate is to be obtained, the monohydrate may be subjected, for example, to drying by heating.

The method for producing lithium hydroxide according to the fifteenth embodiment of the present embodiment is the fourteenth embodiment, in which
the lithium hydroxide has a purity of 98% or more.

The production method of the present embodiment can produce lithium hydroxide having a high purity, e.g., 98% or more.

The method for producing lithium hydroxide according to the sixteenth embodiment of the present embodiment is any one of the first to fifteenth embodiments, in which
the solid raw material containing lithium carbonate is a solid raw material containing lithium carbonate derived from recycle of a battery selected from a lithium ion battery and an all-solid-state lithium ion battery.

In the production method of the present embodiment, a lithium ion battery and an all-solid-state lithium ion battery can be preferably used as the solid raw material containing lithium carbonate.

The electrochemical apparatus according to the seventeenth embodiment of the present embodiment
includes a lithium permselective membrane, and
recovers lithium ion to a recovery liquid, from a lithium ion aqueous solution obtained by subjecting a calcium carbonate-containing liquid obtained by mixing a solid raw material containing lithium carbonate, and a calcium compound, in a medium, to solid-liquid separation, so as to remove a solid matter containing calcium carbonate.

The electrochemical apparatus of the present embodiment includes a lithium permselective membrane, and thereby can efficiently recover only lithium. Therefore, the use of the electrochemical apparatus enables the efficient production of lithium hydroxide having a high purity.

The method for producing a lithium-containing substance according to the eighteenth embodiment of the present embodiment includes
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate,
recovering lithium ion from a lithium ion aqueous solution having a concentration of lithium ion of 3,000 ppm by mass or more obtained through the solid-liquid separation, to a recovery liquid, with an electrochemical apparatus including a lithium permselective membrane,
obtaining lithium hydroxide from the recovery liquid, and
producing a lithium-containing substance selected from lithium sulfide, a sulfide solid electrolyte, and an electrode active substance, by using the lithium hydroxide.

The method for producing a lithium-containing substance of the present embodiment is a method for producing a lithium-containing substance selected from lithium sulfide, a sulfide solid electrolyte, and an electrode active substance, by using lithium hydroxide obtained by the method for producing lithium hydroxide of the present embodiment described above. The method for producing lithium hydroxide of the present embodiment can efficiently produce lithium hydroxide having a high purity as described above, and as a result, the method for producing a lithium-containing substance of the present embodiment can efficiently produce the lithium-containing substance.

The method for producing a lithium ion battery according to the nineteenth embodiment of the present embodiment includes
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate,
recovering lithium ion from a lithium ion aqueous solution having a concentration of lithium ion of 3,000 ppm by mass or more obtained through the solid-liquid separation, to a recovery liquid, with an electrochemical apparatus including a lithium permselective membrane.
obtaining lithium hydroxide from the recovery liquid,
producing a lithium-containing substance selected from lithium sulfide, a sulfide solid electrolyte, and an electrode active substance, by using the lithium hydroxide, and using the substance selected from the lithium-containing substances.

The method for producing a lithium ion battery of the present embodiment is a method for producing a lithium ion battery by mixing a lithium-containing substance selected from the lithium-containing substance obtained by the method for producing a lithium-containing substance of the present embodiment. The method for producing a lithium-containing substance of the present embodiment can efficiently produce a lithium-containing substance as described above, and as a result, the method for producing a lithium ion battery of the present embodiment can efficiently produce a lithium ion battery.

### [Method for Producing Lithium Hydroxide]

The method for producing lithium hydroxide of the present embodiment is
a production method including
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate,
recovering lithium ion from a lithium ion aqueous solution obtained through the solid-liquid separation, to a recovery liquid, with an electrochemical apparatus including a lithium permselective membrane, and
obtaining lithium hydroxide from the recovery liquid,
the lithium ion aqueous solution having a concentration of lithium ion of 3,000 ppm by mass or more.

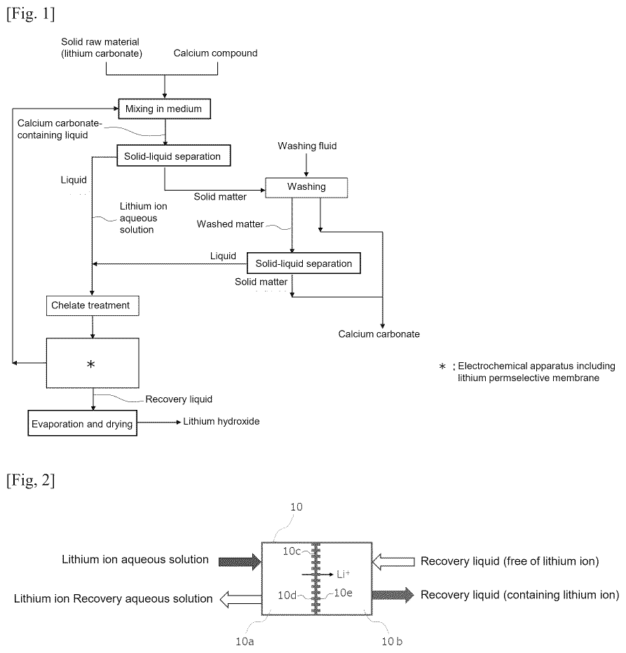

The method for producing lithium hydroxide of the present embodiment will be described in more detail below with reference to the flow chart shown in FIG. 1.

The flow chart shown in FIG. 1 is a flow chart showing one preferred embodiment of the method for producing lithium hydroxide of the present embodiment. As shown in the flow chart shown in FIG. 1, a solid raw material containing lithium carbonate, and a calcium compound are mixed in a medium, a calcium carbonate-containing liquid is obtained through the mixing, and is subjected to solid-liquid separation and separated into a solid matter and a liquid, and the liquid is fed as a lithium ion aqueous solution to an electrochemical apparatus including a lithium permselective membrane. Then, a recovery liquid obtained by recovering lithium ion with the electrochemical apparatus is subjected to a treatment, such as evaporation, so as to provide lithium hydroxide.

The flow chart shown in FIG. 1 also shows treatments and the like that are preferably included in the production method of the present embodiment.

A chelate treatment shown in FIG. 1 is a treatment that is preferably performed, and FIG. 1 shows that the lithium ion aqueous solution is subjected to the chelate treatment and then fed to the electrochemical apparatus.

Washing a solid matter obtained through the solid-liquid separation with a washing fluid is also one preferred embodiment, which shows that a washed matter obtained by washing with the washing fluid is further subjected to solid-liquid separation, and a liquid obtained is mixed with the lithium ion aqueous solution and fed to the electrochemical apparatus since the liquid contains lithium ion. A solid matter obtained is calcium carbonate having a high purity due to the washing.

FIG. 1 also shows that a lithium ion recovered aqueous solution after recovering lithium ion with the electrochemical apparatus is reused in mixing the solid raw material and the calcium compound.

### [Mixing]

The production method of the present embodiment includes mixing a solid raw material containing lithium carbonate, and a calcium compound, in a medium, so as to provide a calcium carbonate-containing liquid.

### (Medium)

The medium used in mixing the solid raw material containing lithium carbonate, and a calcium compound is preferably a liquid, more preferably a liquid capable of dissolving lithium carbonate, the calcium compound, and the reaction product thereof, and particularly water, in consideration of the removal of the solid matter performed after the mixing, the recovery of lithium ion to a recovery liquid with an electrochemical apparatus, and the like. Water can easily provide the lithium ion aqueous solution, can accelerate the reaction of lithium carbonate contained in the solid raw material and the calcium compound, and can allow only lithium to be recovered more efficiently, enabling the more efficient production of lithium hydroxide having a high purity. Furthermore, water is easy to handle.

### (Solid Raw Material)

The solid raw material used in the production method of the present embodiment is not particularly limited, as long as containing lithium carbonate. Examples of the solid raw material containing lithium carbonate include a solid raw material obtained by condensing seawater, salt lake brine water, mining wastewater, geothermal water, or a combination of these solid raw material sources, through means, such as evaporation.

In the production method of the present embodiment, assorted solid raw material sources, for example, low-grade lithium carbonate containing impurities obtained from lithium ion batteries and all-solid-state lithium ion batteries, can be used as the solid raw material. Accordingly, the solid raw material used in the production method of the present embodiment may contain at least one kind of an atom selected from a sodium atom, a potassium atom, a magnesium atom, a calcium atom, an iron atom, a cobalt atom, a nickel atom, a zinc atom, an aluminum atom, a silicon atom, a lead atom, a boron atom, a phosphorus atom, a sulfur atom, a fluorine atom, a chlorine atom, and a bromine atom, in addition to a lithium atom, a carbon atom, and an oxygen atom contained in lithium carbonate.

What atoms the solid raw material contains as the atoms other than a lithium atom, a carbon atom, and an oxygen atom contained in lithium carbonate depends on the solid raw material source from which the solid raw material is obtained, and therefore cannot be unconditionally specified. The content thereof is also cannot be unconditionally specified, and the content of the atoms other than a lithium atom, a carbon atom, and an oxygen atom contained in the solid raw material is generally 5,000 to 300,000 ppm by mass, representative preferred examples of which include ranges of 10 to 200 ppm by mass, 300 to 2,000 ppm by mass, 100 to 800 ppm by mass, 200 to 1,500 ppm by mass, and 1,500 to 4,500 ppm by mass.

The low-grade lithium carbonate that can be used in the production method of the present embodiment may contain water due to moisture absorption, brine water, and the like, and other various impurities. For example, the low-grade lithium carbonate generally contains a lithium atom, a boron atom, a sodium atom, a potassium atom, a magnesium atom, a calcium atom, and the like, and the content thereof in terms of metal atom is generally 5,000 to 300,000 ppm by mass, representative preferred examples of which include ranges of 10 to 200 ppm by mass, 300 to 2,000 ppm by mass, 100 to 800 ppm by mass, 200 to 1,500 ppm by mass, and 1,500 to 4,500 ppm by mass.

The low-grade lithium carbonate may also contain a chlorine atom, a zinc atom, an aluminum atom, a lead atom, and the like in addition to the above in some cases, and in these cases, the content of a chlorine atom is generally 300 to 2,000 ppm by mass, and the content of a zinc atom, an aluminum atom, and a lead atom in terms of metal atom is generally 0.5 to 50 ppm by mass, representative preferred examples of which include ranges of 0.1 to 10 ppm by mass and 0.1 to 20 ppm by mass. A sulfate salt may also be contained in a content of 50 to 1,000 ppm by mass in terms of SO₄.

The low-grade lithium carbonate derived from recycle of batteries selected from a lithium ion battery and an all-solid-state lithium ion battery may contain a cobalt atom, a nickel atom, a silicon atom, a phosphorus atom, a fluorine atom, and a bromine atom in some cases. The low-grade lithium carbonate used in the production method of the present embodiment may vary depending on the properties of the brine water and the kind of the lithium ion battery and the all-solid-state lithium ion battery subjected to recycle. Therefore, the aforementioned low-grade lithium carbonate is described merely as one example of the material having representative properties, and it should be noted that the low-grade lithium carbonate is not limited to those described above.

### (Calcium Compound)

The calcium compound used is not particularly limited, as long as being a compound capable of forming calcium carbonate through reaction with lithium carbonate, in which calcium hydroxide and calcium chloride are preferred, and calcium hydroxide is more preferred among them. These calcium compounds are easily reacted with lithium carbonate, by which only lithium can be recovered more efficiently, enabling the more efficient production of lithium hydroxide having a high purity, and can be easily formed into an aqueous solution with good handleability.

These calcium compounds each may be used alone, or two kinds thereof may be used in combination.

The content of the calcium compound is preferably 0.3 mol/L or more, more preferably 0.5 mol/L or more, further preferably 0.75 mol/L or more, and still further preferably 1.0 mol/L or more, based on the total amount of the calcium carbonate-containing liquid, and the upper limit thereof is preferably 3.0 mol/L or less, more preferably 2.5 mol/L or less, further preferably 2.0 mol/L or less, and still further preferably 1.7 mol/L or less. The content of the calcium compound can also be comprehended as the amount (mol) of the calcium compound used per 1 L of the medium. The numerical range thereof can be obtained by optionally combining the upper limits and the lower limits described above, representative preferred examples of which include 0.3 to 3.0 mol/L, 0.3 to 2.5 mol/L, 0.3 to 2.0 mol/L, 0.3 to 1.6 mol/L, 0.5 to 3.0 mol/L, 0.5 to 2.5 mol/L, 0.5 to 2.0 mol/L, 0.5 to 1.6 mol/L, 0.75 to 3.0 mol/L, 0.75 to 2.5 mol/L, 0.75 to 2.0 mol/L, 0.75 to 1.6 mol/L, 1.0 to 3.0 mol/L, 1.0 to 2.5 mol/L, 1.0 to 2.0 mol/L, and 1.0 to 1.6 mol/L.

In the case where the content thereof is in the range, calcium carbonate can be formed more efficiently through the reaction of lithium carbonate and the calcium compound, and as a result, only lithium can be recovered more efficiently, enabling the more efficient production of lithium hydroxide having a high purity.

As for the amount of the calcium compound used, the amount of the calcium compound used per 1.0 mol of lithium carbonate is preferably 1.0 mol or more, and the upper limit thereof is preferably 2.0 mol or less, more preferably 1.8 mol or less, further preferably 1.5 mol or less, and still further preferably 1.2 mol or less. In particular, it is preferred that 1.0 mol thereof, i.e., the same molar number of the calcium compound as lithium carbonate is used.

In the case where the content thereof is in the range, calcium carbonate can be formed more efficiently through the reaction of lithium carbonate and the calcium compound, enabling the reduction of the concentration of calcium ion contained in the lithium ion aqueous solution, and as a result, only lithium can be recovered more efficiently, enabling the more efficient production of lithium hydroxide having a high purity.

### (Mixing)

The mixing in the mixing the solid raw material containing lithium carbonate, and the calcium compound in the medium may be performed to such an extent that causes calcium carbonate through the reaction of lithium carbonate and the calcium compound, and the mixing may be performed with an apparatus that is generally referred to as an agitator or a mixer.

The mixing the solid raw material containing lithium carbonate, and the calcium compound in the medium may be performed, for example, in such a manner that the solid raw material containing lithium carbonate, and the calcium compound are fed to the medium, such as water, and mixed therein, a mixture obtained by mixing the solid raw material containing lithium carbonate with water in advance is mixed with the calcium compound, a mixture obtained by mixing the calcium compound with water in advance is mixed with the solid raw material containing lithium carbonate, or a mixture obtained by mixing the solid raw material containing lithium carbonate with water in advance is mixed with a mixture obtained by mixing the calcium compound with water in advance.

In consideration of the easiness of the operation, it is preferred that the solid raw material containing lithium carbonate, and the calcium compound are fed to the medium, and mixed therein.

Examples of the agitator and the mixer include a mechanical agitation mixer capable of performing agitation (i.e., mixing through agitation, which may also be referred to as agitation mixing), equipped with an agitation bar or an agitation blade in the reaction tank. Examples of the mechanical agitation mixer include a high-speed agitation mixer and a double arm mixer, and examples of the high-speed agitation mixer include a vertical axis rotation mixer and a horizontal axis rotation mixer.

In the production method of the present embodiment, any type of mixers may be used, which may be determined depending on the processing amount and the like.

The mixing time may be such an extent that can form calcium carbonate through the reaction of lithium carbonate and the calcium compound with no particular limitation, and is generally 1 minute or more, preferably 10 minutes or more, more preferably 30 minutes or more, further preferably 1 hour or more, and still further preferably 3 hours or more, and the upper limit thereof is generally 10 hours or less, preferably 8 hours or less, more preferably 6 hours or less, and further preferably 5 hours or less.

The temperature condition in mixing may be such an extent that can form calcium carbonate through the reaction of lithium carbonate and the calcium compound with no particular limitation, and is generally 10° C. or more, preferably 15° C. or more, and more preferably 20° C. or more, and the upper limit thereof may be a temperature at which the calcium carbonate-containing liquid does not boil, and is generally 98° C. or less, and preferably 95° C. or less.

There is a tendency that the production efficiency of lithium hydroxide is slightly enhanced by mixing under heating, and in consideration of suppressing the consumption energy, it is also preferred that the temperature condition is room temperature (23° C.±3° C.) with no particular regulation. In the case where the production efficiency is particularly considered, the mixing may be performed under heating within the range of the aforementioned upper limit temperature.

### [Removing Solid Matter]

The production method of the present embodiment includes subjecting the calcium carbonate-containing liquid to solid-liquid separation, so as to remove a solid matter containing calcium carbonate. Through the solid-liquid separation, the solid matter containing calcium carbonate contained in the calcium carbonate-containing liquid is removed, and simultaneously the liquid thus separated becomes a lithium ion aqueous solution.

### (Solid-Liquid Separation)

The method of the solid-liquid separation is not particularly limited, as long as being capable of separating the solid matter containing calcium carbonate and the liquid contained in the calcium carbonate-containing liquid, and removing the solid matter containing calcium carbonate.

For example, a solid-liquid separation apparatus that has been ordinarily used for solid-liquid separation may be used, and examples of the solid-liquid separation apparatus used include a vacuum filter, a pressure filter, a centrifugal separator, a belt press, and a screw press.

### (Lithium Ion Aqueous Solution)

The lithium ion aqueous solution as the liquid obtained through the solid-liquid separation contains lithium ion, and the concentration thereof is 3,000 ppm by mass or more. In the case where the concentration of lithium ion is 3,000 ppm by mass or more, lithium hydroxide having a high purity can be efficiently obtained with the electrochemical apparatus including a lithium permselective membrane even though the lithium ion aqueous solution contains calcium ion.

The concentration of lithium ion contained in the lithium ion aqueous solution is preferably 4,000 ppm by mass or more, more preferably 6,000 ppm by mass or more, further preferably 8,000 ppm by mass or more, and still further preferably 10,000 ppm by mass or more. As the concentration of lithium ion is preferably as high as possible, the upper limit value of the concentration of lithium ion is not particularly limited, and is generally 15,000 ppm by mass or less, and preferably 12,000 ppm by mass or less. In the case where the concentration of lithium ion is in the range, only lithium can be recovered more efficiently, and lithium hydroxide having a high purity can be obtained more efficiently.

The concentration of calcium ion contained in the lithium ion aqueous solution is generally 20 ppm by mass or less. The concentration of calcium ion is preferably 18 ppm by mass or less, more preferably 15 ppm by mass or less, and further preferably 10 ppm by mass or less. As the concentration of calcium ion is preferably as low as possible, the lower limit of the concentration thereof is not particularly limited, and is practically approximately 0.1 ppm by mass. In the case where the concentration of calcium ion is in the range, only lithium can be recovered more efficiently, and lithium hydroxide having a high purity can be obtained more efficiently. A chelate treatment described later can be performed for reducing the concentration of calcium ion.

### (Solid Matter and Washing)

A solid matter containing calcium carbonate is obtained through the solid-liquid separation. The solid matter is obtained through the solid-liquid separation of the calcium carbonate-containing liquid containing the solid matter and the liquid, and therefore may contain the liquid. i.e., the lithium ion aqueous solution, entrained therein in some cases.

For providing calcium carbonate having a high purity, the production method of the present embodiment preferably includes washing the solid matter with a washing fluid as shown in FIG. 1. Furthermore, the lithium ion aqueous solution entrained in the solid matter can be recovered by washing, and a larger amount of lithium can be recovered thereby.

The washing fluid used is not particularly limited, as long as being capable of washing calcium carbonate and recovering the lithium ion aqueous solution entrained in the solid matter, and is preferably water. With the use of water, the lithium ion aqueous solution entrained in the solid matter can be fed to the liquid separated through the solid-liquid separation described above, and lithium ion contained in the lithium ion aqueous solution entrained in the solid matter can be easily recovered.

In the washing the solid matter, the amount of the washing fluid used is preferably 2 times or more, more preferably 3 times or more, and further preferably 4 times or more, with respect to the mass of the solid matter, and the upper limit thereof is not particularly limited, may be 10 times or less, and in consideration of the efficient washing, is preferably 8 times or less, more preferably 6 times or less, and further preferably 5 times or less.

In the case where the solid matter is washed with the washing fluid, the method preferably includes subjecting the washed matter formed through the washing to solid-liquid separation as shown in FIG. 1. The washed matter formed through the washing contains washed calcium carbonate having a high purity as a solid matter, and also contains a liquid containing a lithium ion aqueous solution. The solid-liquid separation of the washed matter can provides washed calcium carbonate having a high purity, and also provides a liquid containing a lithium ion aqueous solution.

The liquid obtained through the solid-liquid separation of the washed matter contains the lithium ion aqueous solution entrained in the solid matter and the washing fluid, and in the case where the washing fluid is water, can be referred to as a lithium ion aqueous solution. In the production method of the present embodiment, it is preferred that the liquid obtained through the solid-liquid separation of the washed matter is mixed with the lithium ion aqueous solution obtained through the solid-liquid separation of the calcium carbonate-containing liquid. According to the procedure, lithium ion contained in the lithium ion aqueous solution entrained in the solid matter containing calcium carbonate can be fed to the electrochemical apparatus including a lithium permselective membrane, and thereby a larger amount of lithium can be recovered.

### (Chelate Treatment)

The production method of the present embodiment preferably further includes subjecting the lithium ion aqueous solution to a chelate treatment as shown in FIG. 1. The chelate treatment of the lithium ion aqueous solution facilitates the reduction of calcium ion contained in the lithium ion aqueous solution, and thereby only lithium can be recovered more efficiently, enabling the more efficient production of lithium hydroxide having a high purity.

The method of the chelate treatment may be a known method, and for example, may be performed by using a chelate adsorbent, such as a chelate resin. The chelate adsorbent generally has a ligand forming a complex through coordination to a metal ion with a water insoluble polymer substrate, and has a function of selectively adsorbing and isolating a particular metal ion, and a chelate adsorbent that selectively adsorbs and isolates calcium is used in the production method of the present embodiment.

Preferred examples of the chelate adsorbent include a chelate resin having a sulfonic acid group, a phosphonic acid group, an iminodiacetic acid group, an aminophosphoric acid group, an amidoxime group, a polyamino group, or a quaternary ammonium group, as a functional group, in which a chelate resin having an iminodiacetic acid group is preferred.

The ion type of the chelate resin may be a hydrogen type or may be a sodium type or a calcium type, in which a sodium type is preferred.

The method of the chelate treatment used is not particularly limited, and may be any of a continuous flow system (for example, a system performing the chelate treatment by switching an adsorption process and an elution system alternately by using multiple chelate adsorption towers) and a batch system (for example, a system performing the chelate treatment through agitation or the like in a chelate treatment tank having a chelate adsorbent housed therein).

The concentration of calcium ion of the lithium ion aqueous solution after subjecting to the chelate treatment becomes a significantly low concentration, for example, 10 ppm by mass or less, 8 ppm by mass or less, 6 ppm by mass or less, or 4 ppm by mass or less.

### [Recovering to Recovery Liquid]

The production method of the present embodiment includes recovering lithium ion from the lithium ion aqueous solution obtained through the solid-liquid separation, to a recovery liquid, with an electrochemical apparatus including a lithium permselective membrane. The use of the electrochemical apparatus including a lithium permselective membrane enables the efficient recovery of only lithium ion contained in the lithium ion aqueous solution.

The expression “only lithium ion” herein means that substantially no other ion than Li ion is contained, and means that the content of the other ions is 0.5% by mass or less.

### (Electrochemical Apparatus Including Lithium Permselective Membrane)

In the production method of the present embodiment, lithium ion contained in the lithium ion aqueous solution is recovered to the recovery liquid with the electrochemical apparatus including a lithium permselective membrane. The lithium ion aqueous solution is obtained in the manner as described above that the calcium carbonate-containing liquid obtained by mixing the solid raw material containing lithium carbonate, and the calcium compound in the medium is subjected to solid-liquid separation, from which the solid matter containing calcium carbonate is removed.

The electrochemical apparatus is not particularly limited in system thereof, as long as including a lithium permselective membrane, and examples of the simplest configuration thereof include an apparatus having a configuration including a water tank partitioned with a lithium permselective membrane, in which one side thereof is a lithium ion aqueous solution tank, whereas the other side is a recovery liquid tank. One preferred embodiment of the electrochemical apparatus including a lithium permselective membrane used in the production method of the present embodiment will be described with reference to FIG. 2.

An electrochemical apparatus 10 shown in FIG. 2 includes a lithium ion aqueous solution tank 10a having stored therein the lithium ion aqueous solution, a recovery liquid tank 10b having stored therein the recovery liquid, and a lithium permselective membrane 10c. The lithium permselective membrane 10c includes a first electrode 10d (anode) on the side of one principal surface (i.e., the side of the lithium ion aqueous solution tank 10a) and a second electrode 10e (cathode) on the side of another principal surface (i.e., the side of the recovery liquid tank 10b). With a voltage applied to the first electrode and the second electrode, lithium ion migrates from the lithium ion aqueous solution to the recovery liquid through the lithium permselective membrane 10c, and thus lithium ion is recovered to the recovery liquid.

The lithium ion aqueous solution obtained by removing the solid matter is fed to the lithium ion aqueous solution tank 10a, and after recovering lithium ion, discharged from the lithium ion aqueous solution tank 10a. The discharged lithium ion recovered aqueous solution after recovering lithium ion may be directly discarded, or may be reused in mixing the solid raw material and the calcium compound in the medium as shown in FIG. 1. The reuse thereof can eliminate the use of a fresh solvent, such as water, enabling the more efficient production of lithium hydroxide.

The recovery liquid having lithium ion recovered therein is subjected to evaporation and drying to provide lithium hydroxide as shown in FIG. 1. FIG. 2 also shows that at the time when the amount of the recovery liquid stored in the recovery liquid tank 10b is decreased, a lithium ion-free recovery liquid (such as pure water) is fed thereto.

The electrochemical apparatus 10 may have a configuration including one tank that is partitioned with the lithium permselective membrane 10c into the lithium ion aqueous solution tank 10a and the recovery liquid tank 10b, or a configuration including two tanks of the lithium ion aqueous solution tank 10a and the recovery liquid tank 10b, which are connected through the lithium permselective membrane 10c.

### (Lithium Permselective Membrane)

The lithium permselective membrane is a membrane having a function of moving lithium ion in the lithium ion aqueous solution to the recovery liquid, and is generally disposed to partition the lithium ion aqueous solution and the recovery liquid.

The lithium permselective membrane is preferably constituted by a lithium permselective membrane body constituted by a lithium superionic conductor having a particularly high ionic conductivity (ionic conductor) and a lithium adsorption layer formed as a thin layer on the lithium ion aqueous solution side thereof.

The use of the lithium superionic conductor as the lithium permselective membrane body increases the ionic current of lithium ion flowing between the electrodes, enabling the enhancement of the recovery efficiency of lithium ion. The lithium ion contained in the lithium ion aqueous solution herein exists in the form of hydrated lithium ion having water molecules coordinated therearound. Therefore, for further enhancing the ionic current, it is effective to achieve such a state that facilitates the removal of the water molecules on the surface of the lithium permselective membrane (i.e., the interface between the lithium permselective membrane and the lithium ion aqueous solution).

Accordingly, the surface of the lithium permselective membrane preferably has formed thereon the lithium adsorption layer adsorbing lithium ion (except for the hydrate) in the lithium ion aqueous solution. Specifically, the lithium permselective membrane is preferably subjected to a surface lithium adsorption treatment. Preferred examples of the lithium adsorption layer include a layer formed by modifying the surface of the material constituting the lithium permselective membrane as described later.

Preferred examples of the material constituting the lithium permselective membrane body include oxides and oxynitrides containing lithium shown below. In other words, the lithium permselective membrane preferably contains an oxides, an oxynitride, or the like containing lithium shown below.

Examples of the oxide containing lithium include lanthanum lithium titanate: (Liₓ,La_{y})TiO_{z} (in which x=3a-2b, y=⅔-a, z=3-b, 0<a≤⅙, 0≤b≤0.06, x>0) (which may be hereinafter referred to as “LLTO”), lanthanum lithium zirconate: Li₇La₃Zr₂O₁₂ (which may be hereinafter referred to as “LLZO”), lanthanum lithium niobate: Li₅La₃Nb₂O₁₂, and lanthanum lithium tantalate: Li₅La₃Ta₂O₁₂, and specific examples of LLTO used include Li_{0.29}La_{0.57}TiO₃ (a≈0.1, b≈0).

These materials can be obtained, for example, as a sintered body formed in such a manner that particles constituted by the materials are mixed with a sintering aid and the like and then sintered at a high temperature (1,000° C. or more). In this case, the surface of the lithium permselective membrane can be constituted as a porous material including fine particles constituted by LLTO bound (sintered) to each other, and thereby the effective surface area of the lithium permselective membrane body can be increased, which is also applicable to other oxides containing Li and oxynitrides described later, but not only to LLTO.

Examples of the oxide containing lithium as the lithium superionic conductor that can be used as the material constituting the lithium permselective membrane body also include, in addition to LLTO, LLZO, and the like above, Li-substituted NASICON (Na superionic conductor) type crystals, such as Li_{1+x+y}Alₓ(Ti,Ge)₂₋ₓSi_{y}P_{3-y}O₁₂ (in which 0≤x≤0.6, 0≤y≤0.6) (Li₂O—Al₂O₃—SiO₂—P₂O₅—TiO₂—GeO₂ based material, which may be hereinafter referred to as “LASiPTiGeO”).

Preferred examples of the oxynitride containing lithium include lithium oxynitride phosphate (Li₃PON, which may be referred to as “LiPON”), a nitride of LLTO (LLTON), a nitride of LLZO (LLZON), and a nitride of LASiPTiGeO (LASiPTiGeON).

The lithium superionic conductor, such as the aforementioned oxides and oxynitrides containing lithium, contains lithium as one of the constitutional elements thereof, and exhibits ionic conductivity through the migration of lithium ion outside the crystals among the lithium sites inside the crystals. Lithium ion can flow in the lithium permselective membrane body, but sodium ion cannot flow in the lithium permselective membrane. At this time, what conducts in the crystals is lithium ion (Li⁺), and hydrated lithium ion existing in the lithium ion aqueous solution along with lithium ion cannot enter the lithium sites and does not conduct in the crystals. This point is the same as the lithium permselective membrane described in WO 2015/020121.

In the case where particularly only a large amount of lithium ion is adsorbed on the surface of the lithium permselective membrane body through the lithium adsorption layer, water molecules of hydrated lithium ion are removed in adsorption to form only lithium ion, and thereby the conduction efficiency of lithium ion in the lithium permselective membrane body (i.e., the ionic current flowing in the lithium permselective membrane body) from the lithium ion aqueous solution side (i.e., the one side of the principal surfaces) to the recovery liquid side (i.e., the other side of the principal surfaces) can be increased.

An anode and a cathode are preferably bonded to the lithium permselective membrane, in which it is preferred that an anode is bonded to the lithium ion aqueous solution side (i.e., the one side of the principal surfaces) of the lithium permselective membrane, and a cathode is attached to the recovery liquid side (i.e., the other side of the principal surfaces) thereof. According to the configuration, the one side of the principal surfaces of the lithium permselective membrane on the lithium ion aqueous solution side and the other side of the principal surfaces thereof on the recovery liquid side are retained to constant positive potential and negative potential, respectively.

The material of the anode and the cathode may be appropriately a metal material that does not cause electrochemical reaction in the lithium ion aqueous solution and the recovery liquid. Examples of the metal material used include a stainless steel. Ti, and a Ti—Ir alloy.

The aforementioned material used as the lithium permselective membrane is in a solid state, and has been known to exhibit conductivity due to Li ion flowing in the similar manner to free electrons in the crystals. Therefore, in the case where the anode is at a positive potential, and the cathode is at a negative potential, lithium ion (positive ion) that reaches the cathode side of the lithium permselective membrane among those in the lithium ion aqueous solution on the anode side is allowed to flow from the anode side of the lithium permselective membrane (i.e., the lithium ion aqueous solution) to the cathode side thereof (i.e., the recovery liquid). The lithium ion reaching the cathode side of the lithium permselective membrane is recovered to the recovery liquid. Consequently, after elapsing the prescribed period of time, the concentration of lithium ion in the lithium ion aqueous solution is decreased, whereas the concentration of lithium ion in the recovery liquid is increased.

The lithium adsorption layer may be formed as a thin layer on the surface of the lithium permselective membrane body by subjecting the lithium permselective membrane body to a chemical treatment. Specifically, the layer can be formed by subjecting one of the principal surfaces of the lithium permselective membrane body (for example, LLTO) to an acid treatment, for example, by exposing the surface to hydrochloric acid or nitric acid for 5 days. It is considered that with the treatment, lithium, which is particularly susceptible to oxidation among the constitutional elements of the lithium permselective membrane body (for example, LLTO), is substituted by hydrogen in the acid to form a substance layer having the similar composition to H_{0.29}La_{0.57}TiO₃ (HLTO). The formation of the thin layer (HLTO) on the surface is evidenced by the X-ray diffractometry according to WO 2017/131051 having a peak existing that is different from that of the lithium permselective membrane body (for example, LLTO).

As the H site in HLTO is originally a site that lithium enters. H is particularly likely to be substituted by lithium ion, but is difficult to be substituted by other ions (such as sodium ion). Accordingly, HLTO functions as the lithium adsorption layer. HLTO is formed through the reaction with an acid, and therefore is formed only on the outermost surface of the lithium permselective membrane body.

### (Recovery Liquid)

The recovery liquid used in the present embodiment is not particularly limited, as long as being a liquid capable of dissolving lithium ion, and may be appropriately selected in consideration of the form of lithium finally provided. For example, preferred examples of the recovery liquid used include pure water, such as distilled water and ion exchanged water.

The recovery liquid is fed as water, such as pure water and ion exchanged water, and becomes the recovery liquid containing lithium ion (which corresponds to the “Recovery liquid (containing lithium ion)” in FIG. 2) through recovery of lithium ion by allowing lithium ion migrating from the lithium ion aqueous solution, and the recovery liquid containing lithium ion becomes the recovery liquid substantially free of lithium ion after providing lithium hydroxide through evaporation, drying, crystallization, or the like. The recovery liquid substantially free of lithium ion can also be reused as the “Recovery liquid (free of lithium ion)” in FIG. 2 instead of pure water, such as distilled water and ion exchanged water.

### (Temperature Condition)

The recovering lithium ion to the recovery liquid is preferably performed at a temperature regulated to 50° C. or more. At a temperature regulated to 50° C. or more, the recovery of lithium ion to the recovery liquid is accelerated, and thereby only lithium can be recovered more efficiently, enabling the more efficient production of lithium hydroxide having a high purity.

While the method of regulating the temperature is not particularly limited, it is preferred to regulate the temperature in at least the recovery liquid tank 10b to 50° C. or more, and it is also possible that temperatures in the recovery liquid tank 10b and the lithium ion aqueous solution tank 10a are regulated to 50° C. or more.

The means for regulating the temperature may be a heat exchanger, such as a jacket type or a heater type, with electricity, a heat medium, or the like, provided inside the tank, or may be a system in which the lithium ion aqueous solution and the recovery liquid are withdrawn from the tanks, heated with a heat exchanger or the like, and then returned to the tanks.

### (Regulation of pH)

The recovering lithium ion to the recovery liquid is preferably performed while regulating the pH of the lithium ion aqueous solution. The regulation of the pH enables the efficient recovery of lithium ion to the recovery liquid. In this case, the pH is preferably regulated to a range of 11 or more and 14 or less. The pH regulated to 11 or more and 14 or less is a regulation target, and as for the pH in a range of 11 or more and 14 or less for the pH of the lithium ion aqueous solution, a pH of 11 may include a value of 10.5 or more and less than 11.5, and a pH of 14 may include a value of 13.5 or more and less than 14.5, which substantially mean a range of 10.5 or more and less than 14.5.

In the case where the pH of the lithium ion aqueous solution is regulated, the means therefor is not particularly limited, and, for example, may be a method of adding an alkaline aqueous solution to the lithium ion aqueous solution. The pH of the lithium ion aqueous solution may also be regulated at the time w % ben lithium ion is recovered to the recovery liquid. Specifically, lithium ion may be recovered to the recovery liquid while regulating the pH of the lithium ion aqueous solution, or the pH may be regulated in advance before recovering lithium ion to the recovery liquid. In the case where the pH of the lithium ion aqueous solution obtained through the solid-liquid separation is in the range, it should be noted that the pH thereof may not be regulated.

Preferred examples of the alkali component of the alkaline aqueous solution used for regulating the pH of the lithium ion aqueous solution include sodium hydroxide, lithium hydroxide, potassium hydroxide, rubidium hydroxide, cesium hydroxide, tetramethylammonium hydroxide, tetraethylammonium hydroxide, calcium hydroxide, barium hydroxide, europium(II) hydroxide, thallium(I) hydroxide, and guanidine. One kind of the alkali component may be used alone, or two or more kinds thereof may be used in combination. Among these, sodium hydroxide is more preferred in consideration of the capability of regulating the pH rapidly.

[Obtaining Lithium Hydroxide from Recovery Liquid]

The method for producing lithium hydroxide of the present embodiment includes obtaining lithium hydroxide from the recovery liquid.

The method of obtaining lithium hydroxide from the recovery liquid is not particularly limited, as long as enabling to obtain lithium hydroxide, and examples thereof include evaporation and drying by heating as shown in FIG. 1. Examples thereof also include a method of separating lithium hydroxide from the recovery liquid. More specifically, preferred examples thereof include crystallization through cooling crystallization, evaporation crystallization, or the like. According to the method using crystallization, lithium hydroxide can be obtained without the use of a dehydration process, such as condensing under heating, and therefore, the energy required by the dehydration process and the like can be reduced, enabling the more efficient production of lithium hydroxide having a high purity.

In the cooling crystallization, the recovery liquid is heated in the step before the crystallization, so as to increase the content of Li ion in the recovery liquid and to increase the temperature difference, and thereby Li ion can be recovered more efficiently. The specific method of the cooling crystallization may be an ordinary cooling crystallization method with no particular limitation, and for example, is preferably performed while blowing an inert gas into the Li ion-containing recovery liquid to retain the positive pressure. The inert gas blown can suppress the formation lithium carbonate, and the formation of lithium hydroxide through the cooling crystallization can be further accelerated, enabling the more efficient production of lithium hydroxide having a high purity.

In the evaporation crystallization, the recovery liquid is heated in the step before the crystallization, and thereby the energy required for evaporation can be suppressed. The specific method of the evaporation crystallization may be an ordinary cooling crystallization method with no particular limitation, and for example, is preferably performed while regulating the temperature preferably to 80° C. or more and 100° C. or less. The temperature regulated is more preferably 85° C. or more and further preferably 90° C. or more, from the standpoint of performing the evaporation crystallization more efficiently.

In the case where lithium hydroxide is obtained through crystallization, the filtrate formed through the crystallization can be reused as the recovery liquid. Lithium ion is recovered as anhydrous lithium hydroxide or hydrated lithium hydroxide from the recovery liquid through the crystallization, and the recovery liquid after removing lithium ion is utilized as a part of pure water that is newly fed as the recovery liquid. The reuse of the filtrate by adding to the recovery liquid can reduce the emission amount of lithium in the filtrate and the emission amount of the filtrate itself, which is a significant advantage. Furthermore, the amount of pure water that is newly fed as the recovery liquid can be reduced, enabling the more efficient production of lithium hydroxide.

A heat exchanger can be provided that is capable of utilizing the exhaust heat of the cooling crystallization and the surplus heat generating in the evaporation crystallization for heating the recovery liquid. According to the configuration, the temperature of the recovery liquid can be easily regulated to 50° C. or more, and thereby the recovery of lithium ion to the recovery liquid is accelerated to achieve the more efficient recovery of only lithium, enabling the more efficient production of lithium hydroxide having a high purity. Furthermore, the thermal efficiency can also be enhanced.

Lithium hydroxide obtained through the crystallization is generally monohydrate (LiOH·H₂O). Lithium hydroxide obtained by the production method of the present embodiment can be directly used or can be used after dehydration depending on purpose. Accordingly, the method for producing lithium hydroxide of the present embodiment provides lithium hydroxide that is in at least one state of lithium hydroxide monohydrate or anhydrous lithium hydroxide.

In the case where lithium hydroxide monohydrate is dehydrated, the dehydration may be performed through ordinarily performed drying, such as heating or depressurization.

The purity of lithium hydroxide obtained by the production method of the present embodiment is, for example, 98% or more, 98.5% or more, or 99% or more. Lithium hydroxide obtained by the production method of the present embodiment can have a significantly high purity.

### [Method for Producing Lithium-Containing Substance]

The method for producing a lithium-containing substance of the present embodiment is a method for producing a lithium-containing substance, including mixing a solid raw material containing lithium carbonate, and a calcium compound, in a medium, so as to provide a calcium carbonate-containing liquid, subjecting the calcium carbonate-containing liquid to solid-liquid separation, so as to remove a solid matter containing calcium carbonate, recovering lithium ion from a lithium ion aqueous solution having a concentration of lithium ion of 3,000 ppm by mass or more obtained through the solid-liquid separation, to a recovery liquid, with an electrochemical apparatus including a lithium permselective membrane, obtaining lithium hydroxide from the recovery liquid, and producing a lithium-containing substance selected from lithium sulfide, a sulfide solid electrolyte, and an electrode active substance, by using the lithium hydroxide. Accordingly, the method for producing a lithium-containing substance of the present embodiment uses lithium hydroxide obtained by the method for producing lithium hydroxide of the present embodiment described above. The method for producing lithium hydroxide adopted in the method for producing a lithium-containing substance of the present embodiment is as described above.

### (Lithium-Containing Substance: Lithium Sulfide)

The lithium-containing substance obtained by the method for producing a lithium-containing substance of the present embodiment is a substance containing lithium selected from lithium sulfide, a sulfide solid electrolyte, and an electrode active material.

Lithium sulfide can be produced, for example, by reacting lithium hydroxide with hydrogen sulfide.

### (Lithium-Containing Substance: Sulfide Solid Electrolyte)

The sulfide solid electrolyte can be produced, for example, by using lithium hydroxide or lithium sulfide obtained using lithium hydroxide as a solid electrolyte raw material, and reacting a raw material-containing substance containing other solid electrolyte raw materials by mixing or the like.

The other solid electrolyte raw material that can be used in combination with lithium hydroxide or lithium sulfide obtained using lithium hydroxide is not particularly limited as long as a sulfide solid electrolyte can be produced, and for example, a substance containing at least one atom selected from a lithium atom, a phosphorus atom, and a sulfur atom is preferably exemplified, and a substance containing at least one atom selected from a lithium atom, a phosphorus atom, a sulfur atom, and a halogen atom is more preferably exemplified.

Typical preferred examples of such solid electrolyte raw materials include raw materials containing at least two kinds of atoms selected from the above-mentioned atoms, such as phosphorus sulfides such as diphosphorus trisulfide (P₂S₃) and diphosphorus pentasulfide (P₂S₅); and raw materials consisting of one kind of atom selected from the above-mentioned atoms, such as elemental phosphorus and elemental sulfur. Among these, lithium sulfide and phosphorus sulfides such as diphosphorus trisulfide (P₂S₃) and diphosphorus pentasulfide (P₂S₅) are preferred, and among the phosphorus sulfides, diphosphorus pentasulfide (P₂S₅) is preferred.

The raw material-containing substance may further contain a halogen atom, and examples of the raw material also include substances containing a halogen atom. Typical examples thereof include lithium halides such as lithium fluoride, lithium chloride, lithium bromide, and lithium iodide; and halogen simple substances such as fluorine (F₂), chlorine (Cl₂), bromine (Br₂), and iodine (I₂).

The above solid electrolyte raw materials may be blended and used at a blending ratio that matches the composition of the sulfide solid electrolyte having a desired crystal structure. Examples of the blending ratio of lithium sulfide and other solid electrolyte raw materials contained in the raw material-containing substance include the blending ratio described in WO 2020/105737 (see paragraphs [0024] to [0028]) and the like. In addition, as the solid electrolyte raw material, it is also possible to appropriately select and use substances exemplified in WO 2020/105737 (see paragraphs [0020] to [0022]) and the like.

The reaction of the raw material-containing substance can be carried out by, for example, the production method (i) mixing, or the production method (ii) heat treatment in a pressure-resistant container or heat treatment in a solvent while refluxing. First, the production method (i) will be described.

### (Regarding Production Method (i))

The method of mixing the solid electrolyte raw materials containing lithium sulfide is not particularly limited as long as, for example, the above-described solid electrolyte raw materials can be mixed. For example, a pulverizer, a mixer, a stirrer, or the like may be used.

When a pulverizer is used, pulverization of the raw materials occurs, but mixing also occurs at the same time. Mixing of the raw materials can also take place using a mixer and a stirrer. Therefore, it can be said that the sulfide solid electrolyte obtained by the method for producing a lithium-containing substance of the present embodiment can be preferably produced by stirring, mixing, pulverizing, or a treatment combining any of these of two or more raw materials selected from substances containing at least one atom of a lithium atom, a sulfur atom, a phosphorus atom, and a halogen atom.

Equipment such as a pulverizer, a mixer, and a stirrer used for mixing the raw material-containing substances is not particularly limited, and equipment that is generally distributed can be used.

In the mixing, a solvent can be added to and mixed with the raw materials. As the solvent, various solvents widely referred to as organic solvents can be used. As the solvent, solvents that have been conventionally used in the production of solid electrolytes can be widely adopted, and examples thereof include hydrocarbon solvents such as aliphatic hydrocarbon solvents, alicyclic hydrocarbon solvents, and aromatic hydrocarbon solvents.

Examples of the solvent include, in addition to the above-described hydrocarbon solvents, a solvent containing a hetero atom such as an atom other than a carbon atom and a hydrogen atom, for example, a nitrogen atom, an oxygen atom, a sulfur atom, and a halogen atom. Such a solvent has a property of easily forming a complex with a raw material or the like containing a lithium atom, a phosphorus atom, a sulfur atom, an oxygen atom, and a halogen atom used as a raw material (hereinafter, such a solvent is also referred to as a “complexing agent”) (since a sulfide solid electrolyte is obtained by removing the complexing agent from the “complex”, the solvent can also be referred to as an “electrolyte precursor”), and has a property of easily keeping the halogen atom in the structure of the sulfide solid electrolyte, and thus is useful in that a higher ionic conductivity is obtained. In addition, in a case where the complexing agent is used, in the mixing of the solid electrolyte raw materials, the reaction of the solid electrolyte raw materials can be allowed to proceed only by using a device such as a mixer or a stirrer, that is, without using a pulverizer, which is useful.

Examples of the complexing agent and the hydrocarbon solvent that can be used include complexing agents and hydrocarbon solvents disclosed in WO 2020/105737 and the like.

As the complexing agent, among the solvents containing a hetero atom, a solvent containing a nitrogen atom is preferred, an amine solvent having an amino group is more preferred, and a diamine solvent having two amino groups is further preferred.

### (Drying)

When the sulfide solid electrolyte is produced and the mixing is performed using a solvent, the method may include drying a fluid (usually, slurry) obtained by the mixing after the mixing is performed. The sulfide solid electrolyte is obtained by removing the complexing agent from the complex containing the complexing agent when the complexing agent is used as the solvent, by removing the complexing agent from the complex containing the complexing agent and removing the solvent when the complexing agent and the solvent are used in combination, or by removing the solvent when the solvent other than the complexing agent is used.

The drying method is not particularly limited as long as the solvent can be removed, and the drying may be performed by solid-liquid separation, drying by heating, reduced pressure drying (vacuum drying), or a combination thereof.

In a case where the complexing agent is used as the solvent and the complexing agent is removed from the complex (electrolyte precursor), as a method of drying, drying by heating is preferable, and drying is preferably performed by a dryer such as a flow type heater. This is because the complexing agent can be quickly removed from the complex (electrolyte precursor), and thus the generation of impurities can be more efficiently suppressed, so that a high-quality sulfide solid electrolyte can be obtained. Preferred examples of the flow type heater include a flash dryer, a spray dryer, and a fluidized dryer using a medium, and among these, a flash dryer is preferred.

### (Heating)

When the sulfide solid electrolyte is produced, heating may be further included. In a case where an amorphous sulfide solid electrolyte (glass component) is obtained by the mixing, a crystalline sulfide solid electrolyte is obtained by heating, and in a case where a crystalline sulfide solid electrolyte is obtained by the mixing, a crystalline sulfide solid electrolyte having a further improved crystallinity is obtained by heating. In any case, by heating, the obtained sulfide solid electrolyte can be made into a crystalline sulfide solid electrolyte, and the ionic conductivity can be improved. That is, it can be said that the heating is an operation performed for crystallization.

In a case where a complexing agent is used as a solvent at the time of mixing, a complex containing the complexing agent is formed, but the complexing agent is removed from the complex even by heating without performing the above-described drying to obtain a sulfide solid electrolyte, and the sulfide solid electrolyte can be amorphous or crystalline depending on the heating conditions.

(Regarding Production Method (ii))

The production method (ii) is a production method in which the reaction of the raw material-containing substance is carried out by heat treatment in a pressure-resistant container or heat treatment in a solvent while refluxing. In a case where the method for producing a sulfide solid electrolyte of the present embodiment employs performing a heat treatment in a pressure-resistant container, the method is suitable for producing a sulfide solid electrolyte having an argyrodite type crystal structure described later. The details of the heat treatment in a pressure-resistant container or the heat treatment in a solvent while refluxing in the production method (ii) are described in JP 2020-095953 and the like, and thus the details may be followed. According to the production methods (i) and (ii), an amorphous sulfide solid electrolyte and a crystalline sulfide solid electrolyte are obtained as the sulfide solid electrolyte. The amorphous sulfide solid electrolyte preferably contains a lithium atom, a sulfur atom, and a phosphorus atom, and preferably further contains a halogen atom. Typical examples thereof include solid electrolytes composed of lithium sulfide, phosphorus sulfide, and a lithium halide, such as Li₂S—P₂S₅, Li₂S—P₂S₅—LiI, Li₂S—P₂S₅—LiCl, Li₂S—P₂S₅—LiBr, and Li₂S—P₂S₅—LiI—LiBr; and solid electrolytes containing other atoms such as an oxygen atom and a silicon atom, such as Li₂S—P₂S₅—Li₂O—LiI and Li₂S—SiS₂—P₂S₅—LiI. From the viewpoint of obtaining higher ionic conductivity, solid electrolytes composed of lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅-Lil-LiBr, are preferred.

The types of atoms constituting the amorphous sulfide solid electrolyte can be determined by, for example, an ICP emission spectrophotometer.

In the amorphous sulfide solid electrolyte, the blending ratio (molar ratio) of lithium atoms, sulfur atoms, phosphorus atoms, and halogen atoms is preferably 1.0 to 1.8:1.0 to 2.0:0.1 to 0.8:0.01 to 0.6, more preferably 1.1 to 1.7:1.2 to 1.8:0.2 to 0.6:0.05 to 0.5, and still more preferably 1.2 to 1.6:1.3 to 1.7:0.25 to 0.5:0.08 to 0.4. Further, when bromine and iodine are used together as halogen atoms, the blending ratio (molar ratio) of lithium atoms, sulfur atoms, phosphorus atoms, bromine, and iodine is preferably 1.0 to 1.8:1.0 to 2.0:0.1 to 0.8:0.01 to 0.3:0.01 to 0.3, more preferably 1.1 to 1.7:1.2 to 1.8:0.2 to 0.6:0.02 to 0.25:0.02 to 0.25, still more preferably 1.2 to 1.6:1.3 to 1.7:0.25 to 0.5:0.03 to 0.2:0.03 to 0.2, and yet still more preferably 1.35 to 1.45:1.4 to 1.7:0.3 to 0.45:0.04 to 0.18:0.04 to 0.18. By setting the blending ratio (molar ratio) of lithium atoms, sulfur atoms, phosphorus atoms, and halogen atoms within the above range, it becomes easy to obtain a solid electrolyte having a thio-LISICON Region II type crystal structure, an argyrodite type crystal structure, or the like to be described later and having a higher ionic conductivity.

The crystalline sulfide solid electrolyte may be a so-called glass ceramic obtained by heating an amorphous sulfide solid electrolyte to a crystallization temperature or higher, and examples of a crystal structure thereof include a Li₃PS₄ crystal structure, a Li₄P₂S₆ crystal structure, a Li₇PS₆ crystal structure, a Li₇P₃S₁₁ crystal structure, and a crystal structure having peaks in the vicinity of 2θ=20.2° and in the vicinity of 23.6° (for example, JP 2013-16423 A).

Preferred examples of the crystal structure include a thio-LISICON Region II type crystal structure and an argyrodite type crystal structure. Details of these crystal structures are described in, for example, WO 2024/010078 and WO 2024/010079.

The composition ratio of the atoms contained in the crystalline sulfide solid electrolyte is a composition ratio according to a compositional formula corresponding to each of the above-described various crystal structures, and is preferably within the range of the composition ratio of each atom contained in the above-described amorphous sulfide solid electrolyte. When the composition ratio of each atom is within the range of the composition ratio of each atom, a thio-LISICON Region 11 type crystal structure or an argyrodite type crystal structure is easily formed among the above-described crystal structures.

The sulfide solid electrolyte thus obtained can be used as it is for a solid electrolyte layer (separator layer) of a lithium ion battery, or can be mixed with an electrode active substance described later and used as an electrode mixture for a positive electrode or a negative electrode.

### (Lithium-Containing Substance: Electrode Active Substance)

The electrode active substance can be produced, for example, by using lithium hydroxide or lithium sulfide obtained using lithium hydroxide as a raw material, mixing the raw material with other raw materials such as hydroxide salts, halide salts, carbonates, and oxides containing atoms such as cobalt, nickel, manganese, iron, and phosphorus by wet mixing or dry mixing, and then firing the mixture.

Preferred examples of the electrode active substance thus obtained include lithium-containing transition metal composite oxides such as LMO (lithium manganate), LCO (lithium cobaltate), NMC (lithium nickel manganese cobaltate), NCA (lithium nickel cobalt aluminate), LNCO (lithium nickel cobaltate), olivine type compounds (LiMeNPO₄, Me=Fe, Co, Ni, Mn), LFP (lithium ferrous phosphate), and NM (lithium nickel manganate). These lithium-containing transition metal composite oxides are also referred to as oxide positive electrode active substances, and are mainly used as positive electrode active substances.

The electrode active substance obtained by the method for producing a lithium-containing substance of the present embodiment can be mixed with, for example, a sulfide solid electrolyte also obtained by the method for producing a lithium-containing substance of the present embodiment, and used as an electrode mixture.

The blending ratio (mass ratio) of the electrode active substance and the sulfide solid electrolyte in the electrode mixture is preferably 99.5:0.5 to 40:60, more preferably 99:1 to 50:50, and still more preferably 98:2 to 60:40, in order to improve battery performance and consider production efficiency.

In addition, in the case of an electrode mixture, as a component other than the electrode active substance and the sulfide solid electrolyte, it is possible to use a conductive material which is a carbon-based material such as artificial graphite, graphite carbon fiber, resin baked carbon, pyrolytic vapor-grown carbon, coke, mesocarbon microbeads, furfuryl alcohol resin baked carbon, polyacene, pitch-based carbon fiber, vapor-grown carbon fiber, natural graphite, and nongraphitizing carbon, and a binder of various resins such as fluorine-based polymers such as polytetrafluoroethylene and polyvinylidene fluoride, thermoplastic elastomers such as butylene rubber and styrene-butadiene rubber, acrylic resin, acrylic polyol resin, polyvinyl acetal resin, polyvinyl butyral resin, and silicone resin.

When containing a conductive material, the content of the conductive material in the electrode mixture is not particularly limited, however in order to improve battery performance and consider production efficiency, it is preferably 0.5% by mass or more, more preferably 1% by mass or more, and still more preferably 1.5% by mass or more, and the upper limit is preferably 10% by mass or less, more preferably 8% by mass or less, and still more preferably 5% by mass or less.

When containing a binder, the content of the binder in the electrode mixture is not particularly limited, however in order to improve battery performance and consider production efficiency, it is preferably 1% by mass or more, more preferably 3% by mass or more, and still more preferably 5% by mass or more, and the upper limit is preferably 20% by mass or less, more preferably 15% by mass or less, and still more preferably 10% by mass or less.

The electrode active substance can be used as an electrode mixture, and the electrode mixture can be used as a positive electrode layer or a negative electrode layer of a lithium ion battery.

### [Method for Producing Lithium Ion Battery]

The method for producing a lithium ion battery of the present embodiment includes mixing a solid raw material containing lithium carbonate, and a calcium compound, in a medium, so as to provide a calcium carbonate-containing liquid, subjecting the calcium carbonate-containing liquid to solid-liquid separation, so as to remove a solid matter containing calcium carbonate, recovering lithium ion from a lithium ion aqueous solution having a concentration of lithium ion of 3,000 ppm by mass or more obtained through the solid-liquid separation, to a recovery liquid, with an electrochemical apparatus including a lithium permselective membrane, obtaining lithium hydroxide from the recovery liquid, producing a lithium-containing substance selected from lithium sulfide, a sulfide solid electrolyte, and an electrode active substance, by using the lithium hydroxide, and using the substance selected from the lithium-containing substances. Accordingly, the method for producing a lithium ion battery of the present embodiment uses the lithium-containing substance obtained by the method for producing a lithium-containing substance of the present embodiment described above. The method for producing a lithium-containing substance adopted in the method for producing a lithium ion battery of the present embodiment is as described above.

The substance selected from lithium-containing substances used in the production method of the present embodiment is a substance selected from lithium sulfide, a sulfide solid electrolyte, and an electrode active substance, and a sulfide solid electrolyte and an electrode active substance are preferably used.

As described above, the sulfide solid electrolyte is preferably used as it is in a solid electrolyte layer of a lithium-ion battery, and is preferably used in a positive electrode or a negative electrode of a lithium ion battery as an electrode mixture by being mixed with an electrode active substance. In addition, the electrode active substance is mixed with a solid electrolyte such as a sulfide solid electrolyte to form an electrode mixture, which is preferably used for a positive electrode or a negative electrode of a lithium ion battery.

The lithium ion battery obtained by the production method of the present embodiment preferably includes, for example, a positive electrode layer, a negative electrode layer, an electrolyte layer, and a current collector. The above-described electrode mixture is preferably used as the positive electrode layer and the negative electrode layer, and the sulfide solid electrolyte obtained by the method for producing a lithium-containing substance of the present embodiment is preferably used as the electrolyte layer.

As the current collector, a known current collector may be used. For example, a layer in which a material that reacts with the solid electrolyte, such as Au, Pt, Al, Ti, or Cu, is covered with Au or the like can be used.

### EXAMPLES

The present invention will be described specifically with reference to examples below, but the present invention is not limited to the examples.

### (Production Apparatus of Lithium Hydroxide)

An apparatus having the configuration of the flow chart shown in FIG. 1 was used. The electrochemical apparatus including a lithium permselective membrane used was an apparatus having the configuration shown in FIG. 2.

### (Production of Lithium Permselective Membrane)

The lithium permselective membrane used was produced in the following manner.

A lithium permselective membrane body containing lanthanum lithium titanate (Li_{0.29}La_{0.57}TiO₃) as a constitutional material was produced, and one of the principal surfaces of the body was exposed to hydrochloric acid at 60° C. for 5 days, so as to produce a lithium permselective membrane including a lithium permselective membrane body (LLTO) having on one principal surface thereof a lithium adsorption layer (HLTO).

### (Measurement of Yield and Purity of Lithium Hydroxide)

A solid matter (which may be referred to as a “cake”) obtained by filtering with the solid-liquid separation device of the production apparatus of lithium hydroxide was placed in a petri dish, and dried at 40° C. for 2 hours in a vacuum dryer (corresponding to a “drying device”) to provide a dried cake. The dried cake was weighed to provide the yield of lithium hydroxide monohydrate in each of Examples and Comparative Example, and the purity thereof was measured by the neutralization titration method.

### Example 1

In a conical flask (capacity: 300 mL), 16.6 g of lithium carbonate (available from Tokyo Kasei Kogyo Co., Ltd., purity: 99.5%) and 16.7 g of calcium hydroxide were placed, to which 150 g of ion exchanged water was charged. The concentrations of lithium carbonate and calcium hydroxide each were 1.5 mol/L. An agitation bar was placed in the conical flask, and mixing was performed with the agitation bar at room temperature (23° C.) for 4 hours (agitation rate: 500 rpm).

The resulting calcium carbonate-containing liquid was subjected to solid-liquid separation through filtration under reduced pressure (with filter paper corresponding to No. 5A defined in JIS P3810:1995), so as to remove the solid matter containing calcium carbonate. Next, the lithium ion aqueous solution in the form of liquid was fed to the lithium ion aqueous solution tank of the electrochemical apparatus including the lithium permselective membrane, and a voltage of 5 V was applied to the electrodes (i.e., the first electrode and the second electrode) on both surfaces of the lithium permselective membrane, so as to recover lithium ion to the recovery liquid. The current value after elapsing 1 hour from the start of the application of voltage was 31 mA. The current value is a numerical value becoming an index of the recovery efficiency of lithium ion, and a larger value thereof means a higher recovery efficiency of lithium ion.

A part (50.0 mL) of the recovery liquid having lithium ion recovered therein after continuing the application of voltage for 70 hours was heated to provide 0.19 g of lithium hydroxide monohydrate. The purity of the resulting lithium hydroxide monohydrate was 99.9%.

The solid matter containing calcium carbonate (concentration of calcium carbonate in solid matter: 62.1% by mass) after the solid-liquid separation was dissolved in hydrochloric acid and analyzed through ion chromatography. The measurement results are shown in Table 1 (i.e., the lithium concentration and the calcium concentration of the solid matter containing calcium carbonate).

The lithium ion aqueous solution after the solid-liquid separation was analyzed through ion chromatography. The measurement results are shown in Table 1.

### Example 2

Lithium hydroxide was obtained in the same manner as in Example 1 except that in Example 1, the mixing of lithium carbonate, calcium hydroxide, and ion exchanged water was performed at 90° C. The measurement results are shown in Table 1.

### Example 3

The same procedure as in Example 1 was performed until the solid-liquid separation of the calcium carbonate-containing liquid. In a conical flask separately provided, 10 g of the solid matter containing calcium carbonate obtained through solid-liquid separation was mixed with 40 g of ion exchanged water as a washing fluid, which were mixed with an agitation bar for 10 minutes (agitation rate: 300 rpm), and washed matter was subjected to solid-liquid separation through filtration under reduced pressure (with filter paper corresponding to No. 5A defined in JIS P3810:1995).

The liquid obtained through the solid-liquid separation was analyzed through ion chromatography. The resulting solid matter (i.e., washed calcium carbonate, concentration of calcium carbonate in solid matter: 94.0% by mass) was dissolved in hydrochloric acid and analyzed through ion chromatography. The measurement results are shown in Table 1 (i.e., the lithium concentration and the calcium concentration of the solid matter containing calcium carbonate).

### Example 4

The same procedure as in Example 1 was performed until the solid-liquid separation of the calcium carbonate-containing liquid except that in Example 1, 33.2 g of lithium carbonate and 33.4 g of calcium hydroxide were placed in a conical flask (capacity: 500 mL), to which 300 g of ion exchanged water was charged. To a conical flask (capacity: 300 mL) having 1.8 g of a chelate absorbent (“Lewatit MonoPlus TP208 (trade name)”, available from AMP Ionex Corporation) placed therein, 250 g of the lithium ion aqueous solution obtained through the solid-liquid separation was charged, and a chelate treatment was performed by mixing with an agitation bar for 3 hours (agitation rate: 500 rpm). Subsequently, solid-liquid separation was performed, and the lithium ion aqueous solution in the form of liquid was analyzed through ion chromatography. The measurement results are shown in Table 1.

Lithium ion was recovered from the lithium ion aqueous solution obtained through the solid-liquid separation to the recovery liquid in the same manner as in Example 1. The current value after elapsing 1 hour from the start of the application of voltage was 53 mA.

### Comparative Example 1

Lithium hydroxide was obtained in the same manner as in Example 1 except that in Example 1, the amount of lithium carbonate used was 14.2 g, calcium hydroxide was not used, and the amount of ion exchanged water used was 993.5 g.

The current value after elapsing 1 hour from the start of the application of voltage was 10 mA.

TABLE 1

| | | | | | | Comparative |
|---|---|---|---|---|---|---|
| | | Example | | | | Example |
| | | 1 | 2 | 3 | 4 | 1 |
| Amount of lithium carbonate | g | 16.6 | 16.6 | 16.6 | 33.2 | 14.2 |
| Amount of calcium compound | g | 16.7 | 16.7 | 16.7 | 33.4 | 0 |
| Amount of ion exchanged water | g | 150 | 150 | 150 | 300 | 993.5 |
| Content of lithium carbonate | mol/L | 1.5 | 1.5 | 1.5 | 1.5 | 0.19 |
| Content of calcium compound | mol/L | 1.5 | 1.5 | 1.5 | 1.5 | 0 |
| Mixing condition | | | | | | |
| Temperature | ° C. | Room | 90 | Room | Room | Room |
| | | temp. | | temp. | temp. | temp. |
| Time | hour | 4 | 4 | 4 | 4 | 4 |
| Washing of solid matter | — | No | No | Yes | No | No |
| Chelate treatment | — | No | No | No | Yes | No |
| Lithium ion aqueous solution 1 | | | | | | |
| Lithium ion concentration | ppm by | 11022 | 11477 | 11022 | 11022 | 2643 |
| | mass | | | | | |
| Calcium ion concentration | ppm by | 12.3 | 13.7 | 12.3 | 12.3 | — |
| | mass | | | | | |
| Lithium ion aqueous solution 2 | | | | | | |
| Lithium ion concentration | ppm by | — | — | 3268 | — | — |
| | mass | | | | | |
| Calcium ion concentration | ppm by | — | — | 1.4 | — | — |
| | mass | | | | | |
| Lithium ion aqueous solution 3 | | | | | | |
| Lithium ion concentration | ppm by | 11022 | — | — | 12773 | 2643 |
| | mass | | | | | |
| Calcium ion concentration | ppm by | 12.3 | — | — | 3.2 | — |
| | mass | | | | | |
| pH | — | 11.6 | — | — | 11.6 | 11.4 |
| Solid matter containing calcium | | | | | | |
| carbonate | | | | | | |
| Lithium concentration | % by mass | 12.5 | — | 1.5 | — | — |
| Calcium concentration | % by mass | 87.5 | — | 98.5 | — | — |
| Electrochemical apparatus | | | | | | |
| Applied voltage | V | 5 | — | — | 5 | 5 |
| Current value | mA | 31 | — | — | 53 | 10 |
| Lithium hydroxide | | | | | | |
| Purity | % | 99.9 | — | — | — | — |
| Yield | g | 0.19 | — | — | — | — |

Note: In Table 1, the lithium ion aqueous solution 1 means the lithium ion aqueous solution obtained through solid-liquid separation, the lithium ion aqueous solution 2 is the liquid obtained by washing the solid matter containing calcium carbonate, and subjecting the resulting washed matter to solid-liquid separation, and the lithium ion aqueous solution 3 is the lithium ion aqueous solution fed to the electrochemical apparatus.

In Examples 1 and 4, the current values after elapsing 1 hour from the start of the application of voltage in the electrochemical apparatus are 31 mA and 53 mA, which are larger than a current value of 10 mA in Comparative Example 1. It is confirmed therefrom that Examples achieve a significantly high recovery efficiency of lithium ion, as compared to Comparative Example 1 using no calcium compound. It is also confirmed from the results of Example 1 that the production method of the present embodiment can provide lithium hydroxide having a high purity with a high yield. It is thus confirmed that the production method of the present embodiment can efficiently provide lithium hydroxide having a high purity. Lithium carbonate having a relatively high purity was practically used in Examples, however in consideration of the further enhancement of the purity of the resulting lithium hydroxide shown by Example 1, it is obvious that the use of low-grade lithium carbonate even can provide lithium hydroxide having a high purity through the enhancement in purity.

The concentration of lithium ion in the lithium ion aqueous solution in Comparative Example 1 is 2,643 ppm by mass, which is understood to be a significantly lower concentration than the concentration of lithium ion of 11,022 ppm by mass in Examples 1 and 4. The content of lithium carbonate in Comparative Example 1 is 0.19 mol/L, and the increase of the amount of lithium carbonate therebeyond causes precipitation of lithium carbonate but not dissolution thereof. Therefore, in the case where the calcium compound is not used, the concentration of lithium ion in the lithium ion aqueous solution cannot be 2,643 ppm by mass or more. According to the production method of the present embodiment, it can be said that the combination use of lithium carbonate and the calcium compound can enhance the concentration of lithium ion in the lithium ion aqueous solution, enabling the more efficient production of lithium hydroxide.

It is confirmed from the results of Example 4 that in the case where the chelate treatment is performed, the calcium concentration of the lithium ion aqueous solution fed to the electrochemical apparatus is 3.2 ppm by mass (see Lithium ion aqueous solution 3 of Example 4 in Table 1), which is reduced to approximately ¼ of 12.3 ppm by mass in Example 1 having no chelate treatment performed. As a result, the current value after elapsing 1 hour from the start of the application of voltage in the electrochemical apparatus is increased from 31 mA to 53 mA, from which it is understood that the recovery efficiency of lithium ion is further enhanced.

It is confirmed from the results of Example 2 that with the temperature condition in mixing of 90° C., the concentration of lithium ion and the concentration of calcium ion in the lithium ion aqueous solution are slightly increased. In the case where more efficient recovery of lithium ion is desired, the mixing may be performed under heating, and in the case where the further reduction of the energy consumption is desired, the mixing may be performed at room temperature.

As shown by the results of Example 1, the solid matter containing calcium carbonate removed through the solid-liquid separation entrains the lithium ion aqueous solution, and lithium ion derived therefrom is detected. It is confirmed from the results of Example 3 that the washing of the solid matter containing calcium carbonate can reduce the content of lithium based on the total amount of metal atoms contained in the solid matter from 12.5% by mass to 1.5% by mass. It is also understood that the liquid obtained through the solid-liquid separation of the washed matter contains lithium ion entrained in the solid matter containing calcium carbonate, and by mixing the liquid with the lithium ion aqueous solution, lithium ion entrained in the solid matter containing calcium carbonate can be recovered, enabling the more efficient recovery of lithium ion.

### REFERENCE SIGN LIST

10: Electrochemical apparatus including lithium permselective membrane
10a: Lithium ion aqueous solution tank
10b: Recovery liquid tank
10c: Lithium permselective membrane
10d: First electrode
10e: Second electrode

1: A method for producing lithium hydroxide, the method comprising
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate and obtain a lithium ion aqueous solution having a concentration of lithium ion of 3,000 Rpm by mass or more,
recovering lithium ion from the lithium ion aqueous solution, to a recovery liquid, with an electrochemical apparatus including a lithium permselective membrane, and
obtaining lithium hydroxide from the recovery liquid.

2: The method according to claim 1, wherein the calcium compound is at least one selected from the group consisting of calcium hydroxide and calcium chloride.

3: The method according to claim 2, wherein the calcium compound is calcium hydroxide.

4: The method according to claim 1, wherein the lithium ion aqueous solution has a concentration of calcium ion of 20 ppm by mass or less.

5: The method according to claim 1, further comprising
subjecting the lithium ion aqueous solution to a chelate treatment.

6: The method according to claim 5, wherein the lithium ion aqueous solution after the chelate treatment has a concentration of calcium ion of 10 ppm by mass or less.

7: The method according to claim 1, comprising
washing the solid matter with a washing fluid, and subjecting a washed matter formed through the washing to solid-liquid separation.

8: The method according to claim 7, wherein a liquid obtained through the solid-liquid separation of the washed matter is mixed with the lithium ion aqueous solution.

9: The method according to claim 1, wherein an amount of the calcium compound used is 1.0 mol or more and 2.0 mol or less per 1.0 mol of lithium carbonate.

10: The method according to claim 1, wherein the recovering to the recovery liquid is performed at a temperature regulated to 50° C. or more.

11: The method according to claim 1, wherein the recovering to the recovery liquid is performed at a pH of the lithium ion aqueous solution regulated to 11 or more and 14 or less.

12: The method according to claim 1, wherein the obtaining lithium hydroxide from the recovery liquid is performed by performing solid-liquid separation through crystallization of the recovery liquid.

13: The method according to claim 1, wherein the solid raw material contains at least one atom selected from the group consisting of a sodium atom, a potassium atom, a magnesium atom, a calcium atom, an iron atom, a cobalt atom, a nickel atom, a zinc atom, an aluminum atom, a silicon atom, a lead atom, a boron atom, a phosphorus atom, a sulfur atom, a fluorine atom, a chlorine atom, and a bromine atom.

14: The method according to claim 1, wherein lithium hydroxide obtained in the obtaining lithium hydroxide is at least one selected from the group consisting of lithium hydroxide monohydrate and anhydrous lithium hydroxide.

15: The method according to claim 14, wherein the lithium hydroxide has a purity of 98% or more.

16: The method according to claim 1, wherein the solid raw material containing lithium carbonate is a solid raw material containing lithium carbonate derived from at least one recycled battery selected from the group consisting of a recycled lithium ion battery and a recycled all-solid-state lithium ion battery.

17: An electrochemical apparatus comprising lithium permselective membrane, and recovering lithium ion to a recovery liquid, from a lithium ion aqueous solution obtained by subjecting a calcium carbonate-containing liquid obtained by mixing a solid raw material containing lithium carbonate, and a calcium compound, in a medium, to solid-liquid separation, so as to remove a solid matter containing calcium carbonate.

18: A method for producing a lithium-containing substance, the method comprising
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate and obtain a lithium ion aqueous solution having a concentration of lithium ion of 3,000 ppm by mass or more,
recovering lithium ion from the lithium ion aqueous solution, to a recovery liquid, with an electrochemical apparatus including a lithium permselective membrane,
obtaining lithium hydroxide from the recovery liquid, and
producing the lithium-containing substance selected from the group consisting of lithium sulfide, a sulfide solid electrolyte, and an electrode active substance, by using the lithium hydroxide.

19: A method for producing a lithium ion battery, the method comprising
mixing a solid raw material containing lithium carbonate, and a calcium compound, in a medium, so as to provide a calcium carbonate-containing liquid,
subjecting the calcium carbonate-containing liquid to solid-liquid separation, so as to remove a solid matter containing calcium carbonate and to obtain a lithium ion aqueous solution having a concentration of lithium ion of 3,000 ppm by mass or more,
recovering lithium ion from the lithium ion aqueous solution, to a recovery liquid, with an electrochemical apparatus including a lithium permselective membrane,
obtaining lithium hydroxide from the recovery liquid,
producing a lithium-containing substance selected from the group consisting of lithium sulfide, a sulfide solid electrolyte, and an electrode active substance, by using the lithium hydroxide, and
producing the lithium ion battery using the lithium-containing substances.
